(19) United States
(12) Patent Application Publication
(10) Pub. No.: US 2024/0273355 A1
(43) Pub. Date: Aug. 15, 2024

(54) GENERAL-PURPOSE NEURAL AUDIO FINGERPRINTING

(71) Applicant: Adobe Inc., San Jose, CA (US)

(72) Inventors: Nicholas J. BRYAN, Belmont, CA (US); Simon JENNI, Hagendorf (CH); John COLLOMOSSE, Woking (GB); Christian James STEINMETZ, London (GB)

(73) Assignee: Adobe Inc., San Jose, CA (US)

(21) Appl. No.: 18/168,236

(22) Filed: Feb. 13, 2023

(51) Int. Cl. G06N 3/08; G06F 16/632

(52) U.S. Cl. CPC G06N 3/08; G06F 16/632

(57) ABSTRACT

Embodiments are disclosed for identifying matching content using neural content fingerprints. The method may include receiving a request to identify content matching a query content item, wherein the query content item is a time varying content item, generating, by an embedding network, a neural fingerprint for the query content item, identifying one or more candidate content items based on the neural fingerprint of the query content item, determining, by a ranking network, one or more similarity scores corresponding to the one or more candidate content items, and identifying one or more matching content items based on the one or more similarity scores.

### BACKGROUND

Audio fingerprinting involves creating a “fingerprint” from audio data. Traditionally, such fingerprints have been generated using a deterministic process such that the same audio data results in the same fingerprint being generated. This allows for databases of fingerprints to be maintained for known audio data. Such databases may then be used to search for audio data that matches an input. Fingerprinting has applications in content identification, copyright management, and in establishing the provenance of content.

### SUMMARY

Introduced here are techniques/technologies that provide robust neural content fingerprinting and content matching. Content items, such as audio data, video data, multimedia data, etc., can be processed by an embedding network to generate a neural content fingerprint. The neural content fingerprint includes a series of embeddings that represent the content item at different points in time. For example, a neural audio fingerprint for an audio recording may include an embedding for each second of the audio recording.

The neural content fingerprints can be used to identify matching content stored in a content data store. In particular, content items stored in the content data store have also had neural content fingerprints generated. The neural content fingerprint of a query is used to identify candidates from the content data store that may match a query content item via a search index. Similarity matrices are generated between the query content item's neural fingerprint and those of the candidates. These are then evaluated using a ranking network that has been trained to identify matching content based on similarity matrices.

Additional features and advantages of exemplary embodiments of the present disclosure will be set forth in the description which follows, and in part will be obvious from the description, or may be learned by the practice of such exemplary embodiments.

### BRIEF DESCRIPTION OF THE DRAWINGS

The detailed description is described with reference to the accompanying drawings in which:

FIG. 1 illustrates a diagram of a process of a content querying system in accordance with one or more embodiments;

FIG. 2 illustrates a diagram of a process of audio querying using a neural content fingerprinting system in accordance with one or more embodiments;

FIG. 3 illustrates a diagram of a neural content fingerprinting system in accordance with one or more embodiments;

FIG. 4 illustrates a diagram of a similarity matrix in accordance with one or more embodiments;

FIG. 5 illustrates a diagram of a ranking network in accordance with one or more embodiments;

FIG. 6 illustrates an example of similarity matrices in accordance with one or more embodiments;

FIG. 7 illustrates an example of matching content in accordance with one or more embodiments;

FIG. 8 illustrates a schematic diagram of a content querying system in accordance with one or more embodiments;

FIG. 9 illustrates a flowchart of a series of acts in a method of content querying using neural fingerprints in accordance with one or more embodiments; and

FIG. 10 illustrates a block diagram of an exemplary computing device in accordance with one or more embodiments.

### DETAILED DESCRIPTION

One or more embodiments of the present disclosure include a neural content fingerprinting system that generates fingerprints for sequence data (e.g., audio data, video data, or other time-varying data). Traditionally, audio fingerprinting systems rely on signal processing techniques, such as SIFT features for images or spectral landmarks for audio. While these approaches have enabled industrial scale applications, they often suffer from a lack of robustness to manipulation (e.g., pitch shifting, time-stretching, etc.). To improve this, neural audio representations have enabled the construction of fingerprinting systems with greater robustness. However, such systems still rely on hard-to-tune heuristic methods such as the Levenshtein distance and histogram approaches when fingerprinting content, such as longer audio queries. Moreover, these systems almost always exclusively focus on music, and as such do not perform well with other audio types such as speech and environmental audio.

To address these and other deficiencies in conventional systems, the neural content fingerprinting system of the present disclosure implements general-purpose neural fingerprinting techniques that produce robust fingerprints for content that can identify content even when it has been altered (e.g., mixed with other content, pitch-shifted, time-stretched, etc.). This results in fingerprints that can be reliably used for content authenticity and provenance discovery. To do so, embodiments construct a robust general purpose audio representation with self-supervised learning and combine this with a learnable ranking network that replaces existing heuristic methods.

As content manipulation has become popular, there is an increased need for accurately identifying the source content that has been manipulated. This may include the original video or audio source that a user or users have manipulated. Content is typically associated with metadata that identifies the source, and other details, associated with the content. However, multimedia content is commonly separated from its associated metadata when users share, re-upload, and manipulate content, motivating fingerprinting solutions that can reconnect known content with their metadata.

The neural fingerprints described herein can be paired with a content querying system which matches an input query to content from one or more content repositories. This allows for the manipulated content to be re-paired with the original source metadata or otherwise identify the original source(s) that were used to create the manipulated content. Additionally, because the neural fingerprints are robust, the source(s) can be identified even in the presence of significant modifications. Further, a content item (e.g., video file, audio file, etc.) may be represented by a series of fingerprints generated at multiple points in time during playback of the content item. For example, a fingerprint may be generated for every second (or more or less frequently) of the content item. This allows for portions of multiple content items that have been mixed together to be identified in manipulated content.

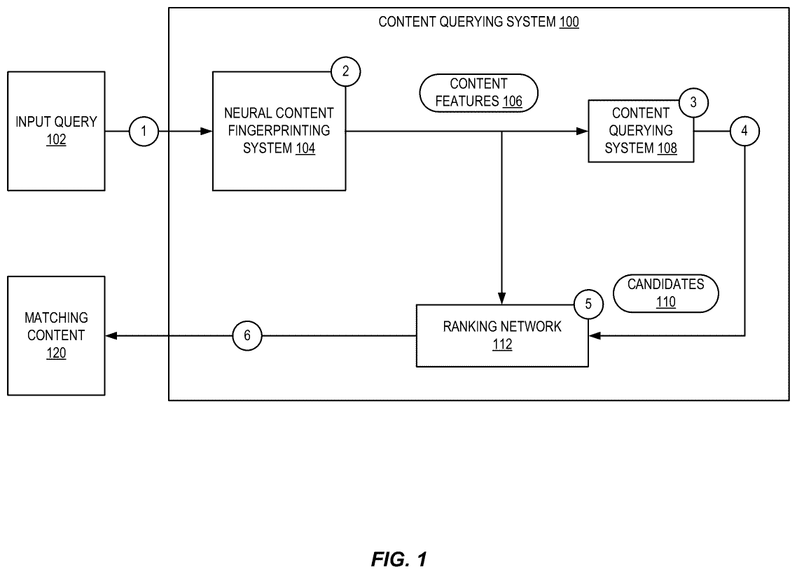

FIG. 1 illustrates a diagram of a process of a content querying system in accordance with one or more embodiments. As shown in FIG. 1, a content querying system 100 can be used to identify known content that matches an input query 102. In some embodiments, content querying system 100 may be implemented as a standalone system or service, or may be implemented as part of another application or service, such as a content management service, content editing application, content verification service, etc.

As shown in FIG. 1, at numeral 1, an input query 102 may be provided to the content querying system 100. The input query 102 may include a content item (e.g., audio file, video file, etc.) or a reference to a content item (e.g., a URL, URI, or other information that can be used to identify the content item in a storage service, file system, etc.). As used herein, content item generally refers to any multimedia content that includes a temporal component. For example, audio data and video data have an associated runtime whereas a still image does not.

At numeral 2, a neural content fingerprinting system 104 obtains the queried content item and generates a neural fingerprint for the content item. In particular, the neural fingerprint may include a series of content features 106 extracted from the content item at a number of points in time. As discussed further herein, the neural content fingerprinting system 104 may include a neural network which generates the content features 106 by encoding the content item at particular points in time. A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data.

These content features 106, at numeral 3, are used by content querying system 108 to identify candidate content items. As discussed further below, the content features can be used with a search index and stored content features to construct one or more similarity matrices. The similarity matrices compare the content features to candidate features of content stored in a content repository. The content repository includes known content for which content features have already been generated. The similarity matrix compares each content feature of the queried content item to each content feature of a stored content item, with each cell of the resulting matrix representing a similarity between two associated content features. Various similarity metrics may be used. For example, in some embodiments, Euclidean distance is calculated between each feature to represent similarity between the features.

Based on the similarity matrices, the content querying system 108 identifies a number of candidate content items 110 are identified and provided to ranking network 112, at numeral 4. In some embodiments, the candidate content items 110 are identified by generating a search index of content features, and querying the content features of the queried content item against the search index to identify the top K matches per query (e.g., using a nearest neighbor search, or other search algorithm). The ranking network 112 replaces the heuristic-based methods from prior techniques, which required manual calibration and lacked robustness in more realistic scenarios leading to performance degradation. Instead, ranking network 112 is trained on retrieval results from a search index, which enables the system to take advantage of a wider range of cues in the similarity between the query and candidate embedding sequences.

At numeral 5, the ranking network 112 produces a similarity score for each candidate similarity matrix to identify matching content. In some embodiments, the similarity score is based on the value of a logit layer of the ranking network, which represents a prediction value. As discussed further herein, the ranking network 112 may include a neural network trained to estimate if a query-candidate pair includes matching content based on their similarity matrix. The matching content 120 is then output at numeral 6. In some embodiments, a single input content item may match multiple content items. For example, the input content item may be comprised of multiple content items that have been combined (e.g., a mash-up, remix, etc.) into a single new content item. Additionally, or alternatively, matching content may be defined as having a similarity score above a threshold value. In such instances, the ranking network may return multiple content items if they each score above the similarity threshold.

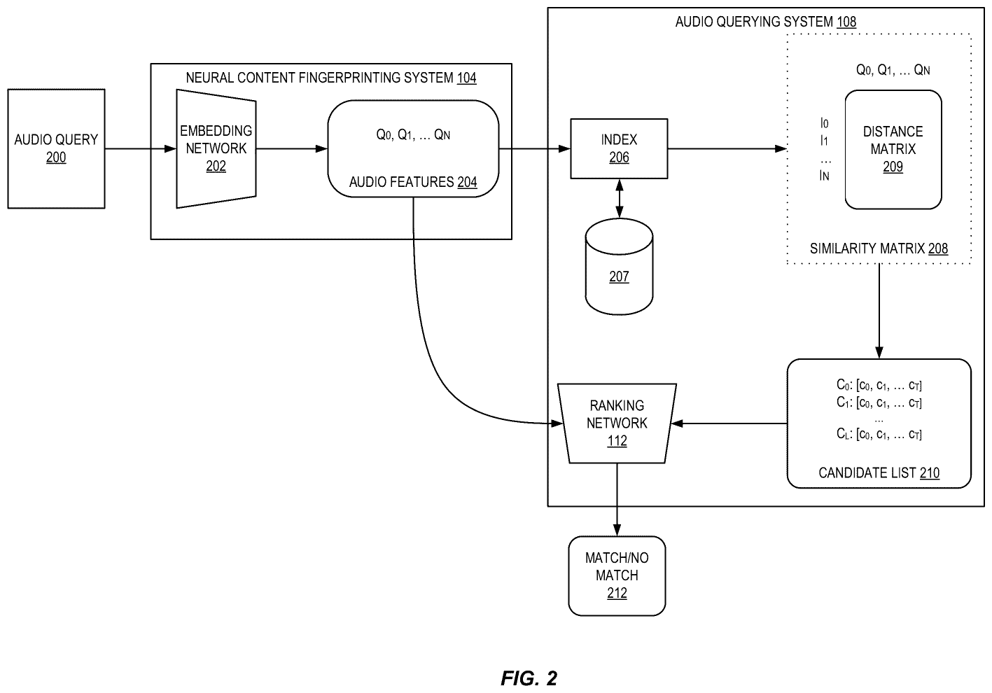

FIG. 2 illustrates a diagram of a process of audio querying using a neural content fingerprinting system in accordance with one or more embodiments. As discussed above, embodiments may be used to fingerprint and match time-varying content, such as audio, video, and/or multimedia content. In the example of FIG. 2, audio content is being queried, however video or multimedia content may be similarly processed.

In the example of FIG. 2, an audio query 200 is received by the neural content fingerprinting system. In some embodiments, the neural content fingerprinting system 104 is a neural audio fingerprinting system. In such instances, the embedding network 202 is trained to generate audio features 204 which are robust across various types of audio (e.g., spoken word, ambient noise, music, etc.). Additionally, or alternatively, the neural content fingerprinting system 104 can receive any type of content and, upon receiving a particular content type, provides the content to a corresponding embedding network trained to generate content features for that content type.

As shown in FIG. 2, when an audio query 200 is received, it is passed to embedding network 202. Embedding network 202 may be a neural network, or other machine learning-based technique, which has been trained to generate audio features 204 (e.g., embeddings) for the audio query 200. In some embodiments, the audio features 204 are generated at different points in time during the playback of the audio query. For example, audio feature Q₀ may be generated at time T₀ and audio feature Q₁ may be generated at time T₁=T₀+δ, where δ represents some time interval or arbitrary difference in time between T₁ and T₀. In some embodiments, an audio feature is generated ever second for the audio query 200.

The audio features 204 may then be provided to audio querying system 108. Audio querying system 108 maintains a search index 206 for an audio database 207. The query audio features 204 and the search index 206 can be used to identify candidate audio recordings that may include matching content using a search algorithm. For example, a nearest neighbor, or other search algorithm, may be used to identify similar features corresponding to content in audio database 207.

Once the similar audio features have been identified, they are used to construct similarity matrices 208. In some embodiments, the similarity matrices may be a plurality of distance matrices 209. The distance matrices may be generated to compare the query audio features 204 to different series of audio features determined from the index. Each distance matrix determines similarity using a distance algorithm (e.g., Euclidean distance, etc.). This allows for the audio features' locations to be compared in feature space and the closest ones are selected as candidates. This results in candidate list 210, with each candidate representing a series of candidate audio features.

As shown in FIG. 2, the candidate list 210 and the query audio features 204 are then evaluated by a ranking network 112. The ranking network 112 scores each retrieved candidate based on its similarity to the query. For example, the ranking network 112 may be a neural network, or other machine learning-based technique, that has been trained to aggregate the results across time to determine a similarity score for each candidate audio content item. The ranking network 112 replaces the heuristic methods from prior techniques for evaluating similarity of matching content items. The ranking network 112 then outputs a match/no match 212 result for each candidate from candidate list 210.

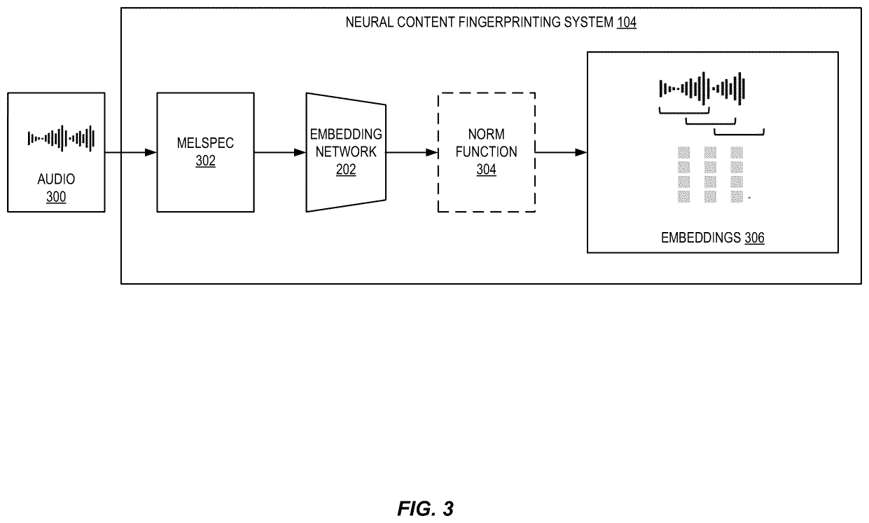

FIG. 3 illustrates a diagram of a neural content fingerprinting system in accordance with one or more embodiments. Embodiments generate robust fingerprints for audio. This means the fingerprints can be generated for different audio types (e.g., music, speed, environmental, etc.). In the example of FIG. 3, audio 300 is received by the neural content fingerprinting system 104. In some embodiments, the audio may include training audio which includes various types of audio, and are used to train embedding network 202. In such instances, the neural content fingerprinting system 104 may be configured in a training mode, in which the embedding network is being trained on a robust audio training dataset prior to the neural content fingerprinting system 104 being deployed for general use.

When the audio 300 is received, the neural content fingerprinting system 104 generates a mel-spectrogram 302 of the audio. This is then provided to embedding network 202 which produces embeddings 306. In some embodiments, the embedding network is trained using a SimCLR-like self-supervised framework. In such instances, the embedding network inputs one second (or other length) of audio per embedding and slides across a longer recording every 0.5 seconds. The embedding network 202 may be implemented using an efficient convolutional neural network (CNN) architecture, a transformer architecture, or a combination thereof. In some embodiments, the embeddings 306 (e.g., audio features) generated by embedding network 202 are normalized using normalization function 304, such as L2 normalization or other normalization function.

To make the resulting embeddings 306 robust (e.g., capable of use with different types of audio), the audio data 300 used to train the embedding network may include a variety of audio types with various augmentations applied to it. In some embodiments, the audio data 300 includes manipulated content, such as adding reverberation, additive noise, gain scaling, ripple delete, high-pass filtering, low-pass filtering, dynamic-range compression, pitch shifting, time-stretching, cropping, etc., to audio items in the audio data 300. In some embodiments, the audio data 300 is an audio dataset, such as a private audio dataset created by an entity for training their models, or a publicly available audio dataset available for training. For example, the AudioSet audio dataset includes over two million general audio recordings from more than six hundred sound event classes. Additionally, the audio data 300 can include audio of varying sampling rates, including audio with a higher sampling rate (8 kHz vs. 16 kHz). This enables the fingerprints to be used for high fidelity audio in addition to lower fidelity audio. In some embodiments, a Normalized Temperature-scaled Cross Entropy Loss (NT-Xent) is used to train the embedding network. The input to this loss function are the embeddings of a training audio signal and the embeddings of the same training audio signal after it has been augmented. This way, the embedding network 202 learns to generate embeddings for augmented audio data that are “close” in embedding space to the embeddings generated for non-augmented audio data.

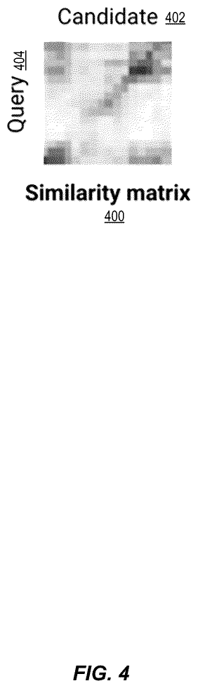

FIG. 4 illustrates a diagram of a similarity matrix 400 in accordance with one or more embodiments. As shown in FIG. 4, similarity matrix 400 represents the similarity of a plurality of candidate embeddings with a plurality of query embeddings. In this example, each row of the similarity matrix corresponds to a different query embedding 404 and each column corresponds to a different candidate embedding 402. The color of each element of the matrix represents a similarity value of the corresponding query embedding and candidate embedding. The similarity value may be calculated using a variety of metrics. In this example, similarity is calculated using Euclidean distance of the corresponding embeddings (e.g., vectors).

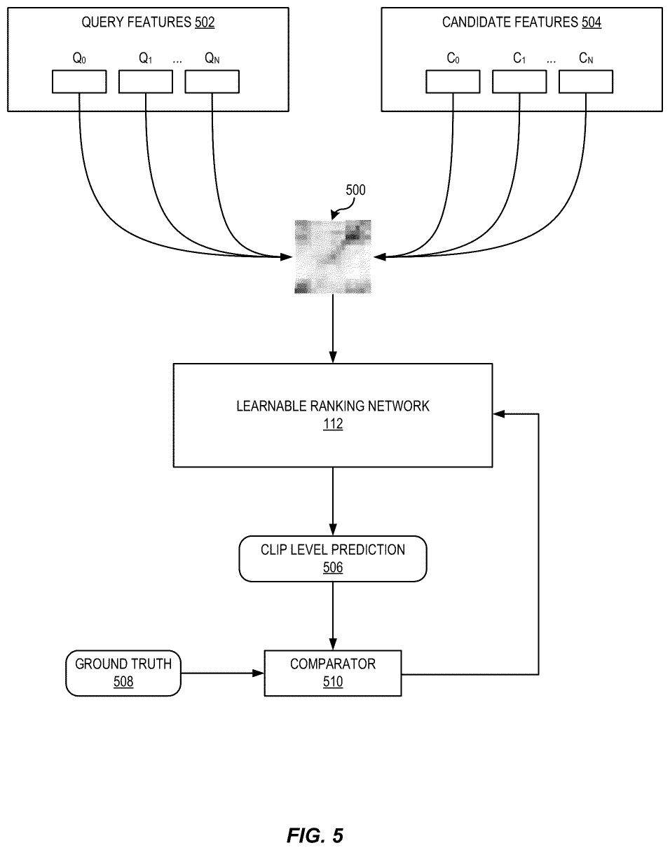

FIG. 5 illustrates a diagram of a ranking network in accordance with one or more embodiments. As discussed, traditional systems rely on heuristic-based time aggregation and ranking methods when comparing fingerprints. While powerful, these methods require manual calibration and lack robustness in more realistic scenarios leading to performance degradation when deployed on real world audio. To address these limitations, embodiments implement a new ranking network that is trained on retrieval results from a search index. Unlike the heuristic methods, this enables the system to take advantage of a wider range of cues in the similarity between the query and candidate embedding sequences.

As discussed above, a similarity matrix S 500 is generated between the sequence of n query features 502 Q=(q₁, q₂, . . . , qₙ) and m candidate features 504 C=(c₁, c₂, . . . , cₘ). As discussed, the query features and candidate features are embeddings generated by an embedding generator. Each entry of the similarity matrix S 500 is given by

$$S ( j , k ) = s ( {q}_{j} , {c}_{k} ) j ∈ ( 1 , … , n ) , k ∈ ( 1 , … , m )$$

where s( ) is a measure of the similarity of the vectors. As discussed, in some embodiments, Euclidean distance is used to determine the similarity of the vectors.

Learnable ranking network 112 is trained to determine whether content matches based on the similarity matrix. In some embodiments, the training of the learnable ranking network is framed as a computer vision task. Accordingly, the learnable training network can be trained using a training dataset that includes similarity matrices that represent the similarity of two series of embeddings. In such an instance, the learnable ranking network may be a 2D convolutional neural network (CNN) that operates on the similarity matrices and performs binary classification by predicting whether each query/candidate pair (e.g., a similarity matrix) includes matching content. In some embodiments, the learnable ranking network may be implemented using a ResNet18 backbone pretrained on ImageNet. However, other architectures and training sets may be used. To train this network, embodiments generate query-candidate pairs (e.g., similarity matrices) by creating queries with a range of manipulations and then performing many retrievals using the pretrained audio representation and existing search index.

For example, in the audio context, the training dataset can include known recordings to which various data augmentations have been applied. This may include remixing with other content, pitch-shifting, time-stretching, etc. The data augmentations used may include, but are not limited to, reverberation (convolution), additive noise, gain, ripple delete, time stretch, pitch shift, reverse, high-pass filter, low-pass filter, dynamic range compression, time-cropping, and/or combinations thereof. These augmentations may vary over time (e.g., the audio may be pitched up for several seconds and then pitched down for several seconds, etc.). During training, the learnable ranking network 112 learns to identify characteristics of audio samples that indicate they are matches even when one sample has been modified using one of these data augmentations.

For example, the learnable ranking network 112 outputs a clip level prediction 506 indicating whether the similarity matrix indicates there is matching content between the query and the candidate. This is compared to the ground truth 508 by comparator 510 and the learnable training network 112 can be trained based on the resulting error signal. Once the learnable training network 112 meets its performance standards, the learnable ranking network is determined to be trained and can be deployed as part of the content query system, as discussed above.

As discussed above, the content querying system matches an input content to one or more known content items in a content datastore. In particular, the learnable ranking network 112 has been trained to predict whether a similarity matrix generated from the input content item and candidate content item(s) match includes matching content. However, in some embodiments, the matching content may not align in the time domain in both the input query and the stored content items. For example, a mash-up of multiple content items may lead to a time offset in the input query as compared to the stored content items.

In some embodiments, the learnable ranking network 112 can further be trained to predict a time offset between matching items. This enables the content querying system to predict matching content and a corresponding time-shift between the two series of embeddings. In such embodiments, the training may use a loss calculated as a weighted average of a binary classification score and the mean squared error between the predicted and target time offset. In some embodiments, the architecture of the learnable ranking network 112 may also be modified to make the time offset prediction. For example, the architecture of the ranking network may be modified so that it predicts the time offset using a second dense layer prediction head from the main network backbone.

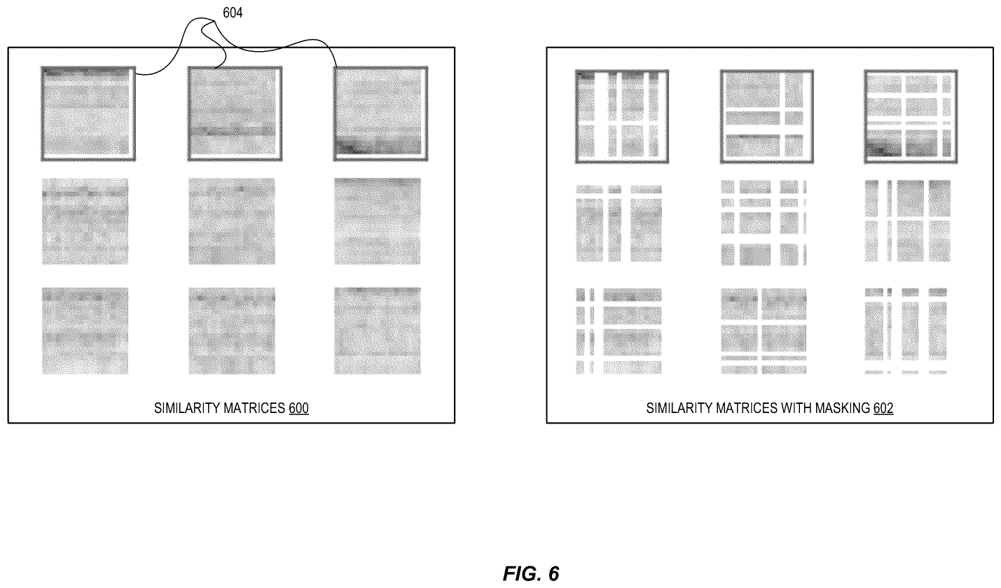

FIG. 6 illustrates an example of similarity matrices in accordance with one or more embodiments. As shown in FIG. 6, a plurality of similarity matrices may be generated for training the learnable ranking network. In this example, similarity matrices 600 includes nine similarity matrices. Outlined matrices 604 signify queries with content that matches an item in the database. To encourage generalization, a further data augmentation may be added to the similarity matrices in addition to the data augmentations discussed above (e.g., those made to the audio files themselves). For example, augmented similarity matrices 602 include nine similarity matrices that have been augmented by randomly masking out rows and columns of the matrices. This effectively fills the masked rows/columns with values indicating that these elements in the similarity matrix are very dissimilar (e.g., represent a large distance between the corresponding vectors).

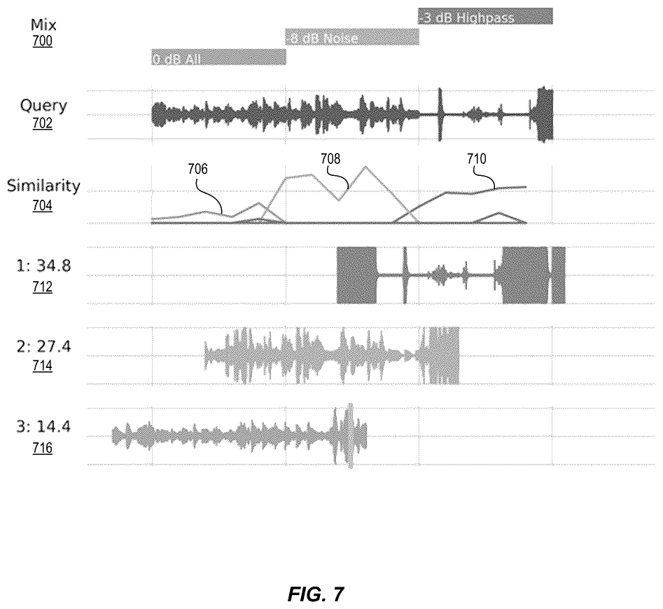

FIG. 7 illustrates an example of matching content in accordance with one or more embodiments. As shown in FIG. 7, a query 702 is received which includes a mix 700 of audio recordings with different manipulations made to each recording. As discussed, audio features are extracted from the query audio at intervals (e.g., every second or other timing). These audio features are then compared to an audio catalog, where each recording in the catalog has similarly had audio features extracted.

The content query system identifies candidate audio recordings and creates similarity matrices with the query audio features. These similarity matrices are then passed to the ranking network which ranks the candidates according to the probability that they include matching audio content.

Similarity 704 illustrates the similarity values over time determined by the learnable ranking network for different audio recordings. During the initial segment 706 of the query, one audio recording has similarity values significantly above the other recordings. This corresponds to recording 716. Similarity at segment 708 and 710, recordings 714 and 712, respectively, are identified as most similar. These are successfully identified even though different manipulations have been applied to the audio in the query. For example, the audio of the initial segment is pitched down compared to matching audio recording 716, and noise has been added to the second segment of the query compared to the matching audio recording 714.

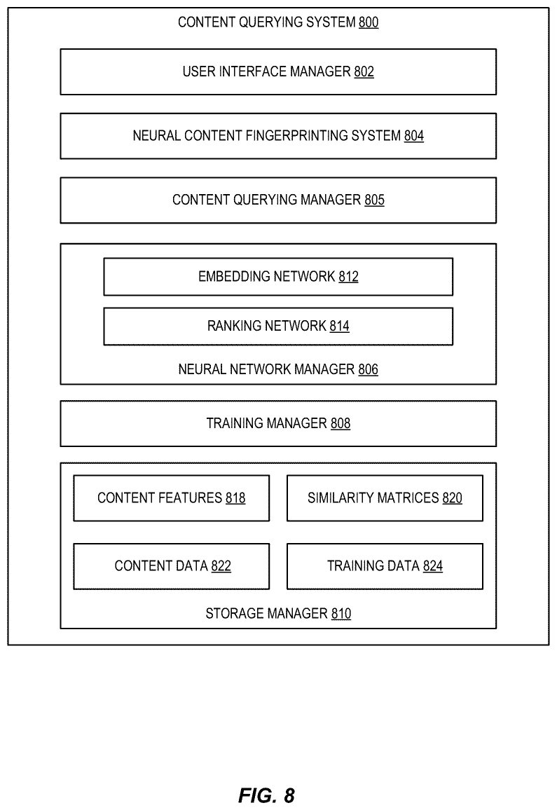

FIG. 8 illustrates a schematic diagram of content querying system (e.g., “content querying system” described above) in accordance with one or more embodiments. As shown, the content querying system 800 may include, but is not limited to, user interface manager 802, neural content fingerprinting system 804, content querying manager 805, neural network manager 806, training manager 808, and storage manager 810. The neural network manager 806 includes an embedding network 812, and a ranking network 814. The storage manager 810 includes content features 818, similarity matrices 820, content data 822, and training data 824.

As illustrated in FIG. 8, the content querying system 800 includes a user interface manager 802. For example, the user interface manager 802 allows users to provide input query data (e.g., audio data, video data, multimedia data, etc.) to the content querying system 800. In some embodiments, the user interface manager 802 provides a user interface through which the user can upload the query which represents the content to be queried against a content database, as discussed above. Alternatively, or additionally, the user interface may enable the user to download the query data from a local or remote storage location (e.g., by providing an address (e.g., a URL or other endpoint) associated with a content source). In some embodiments, the user interface can enable a user to link an image and/or audio capture device, such as a camera or other hardware to capture query data and provide it to the content querying system 800.

Additionally, the user interface manager 802 allows users to request the content querying system 800 to identify any matching content from a content database. In some embodiments, the user may select a specific one or more content databases to be searched. Alternatively, the user interface manager 802 may provide an interface for a single content database. In some embodiments, the user interface manager 802 can act as an orchestrator, invoking other components of the content querying system 800 until matching results are obtained and returned to the user via the user interface.

As illustrated in FIG. 8, the content querying system 800 includes a neural content fingerprinting system 804. As discussed, the neural content fingerprinting system 804 can use an embedding network 812 to generate content features for the received query data. For example, the query data may include time varying data, such as video or audio content. The neural content fingerprinting system 804 can then generate a content feature (e.g., embedding) for each second (or other time period) of the content. This results in content features 818 (e.g., a series of embeddings) that are generated for the query content and represent a “fingerprint” for that query.

As illustrated in FIG. 8, the content querying system 800 includes a content querying manager 805. The content querying manager 805 can maintain a search index for a content library, such as content data 822. The content data 822 may represent one or more databases of content, such as audio data, video data, multimedia data, etc. In some embodiments, the content querying manager obtains the fingerprint of the query data and then uses its search index to identify related content. This may include using a nearest neighbor, or other search algorithm, to identify related content. The content querying manager 805 uses these search results to construct similarity matrices which enable it to identify candidate content, as discussed above.

The candidate content can then be used with the content features 818 to generate similarity matrices 820, which are then passed to ranking network 814. As discussed, ranking network 814 is trained to identify matching content, even in the presence of content manipulations, environmental noise, or other differences between the query data and the known content item. Once the matching content items have been identified using the ranking network, as discussed above, they are returned to the user via the user interface.

As illustrated in FIG. 8, the content querying system 800 also includes a neural network manager 806. Neural network manager 806 may host a plurality of neural networks or other machine learning models, embedding network 812 and ranking network 814. The neural network manager 806 may include an execution environment, libraries, and/or any other data needed to execute the machine learning models. In some embodiments, the neural network manager 806 may be associated with dedicated software and/or hardware resources to execute the machine learning models. As discussed, embedding network 812 and ranking network 814 may be implemented as neural networks, such as convolutional neural networks.

Although depicted in FIG. 8 as being hosted by a single neural network manager 806, in various embodiments the neural networks may be hosted in multiple neural network managers and/or as part of different components. For example, embedding network 812 and ranking network 814 can be hosted by their own neural network managers, or other host environment, in which the respective neural networks execute, or the networks may be spread across multiple neural network managers depending on, e.g., the resource requirements of each network, etc.

As illustrated in FIG. 8 the content querying system 800 also includes training manager 808. The training manager 808 can teach, guide, tune, and/or train one or more neural networks. In particular, the training manager 808 can train a neural network based on a plurality of training data 824. For example, the embedding network 812 may be trained to generate robust fingerprints for content, as discussed above. Additionally, the ranking network 814 may be trained to predict whether a given similarity matrix represents matching content. More specifically, the training manager 808 can access, identify, generate, create, and/or determine training input and utilize the training input to train and fine-tune a neural network.

As illustrated in FIG. 8, the content querying system 800 also includes the storage manager 810. The storage manager 810 maintains data for the content querying system 800. The storage manager 810 can maintain data of any type, size, or kind as necessary to perform the functions of the content querying system 800. The storage manager 810, as shown in FIG. 8, includes the content features 818. The content features 818 can include a series of embeddings generated for the query data by the neural content fingerprinting system 804. In some embodiments, the content features 818 can be maintained for the duration of the query operation and then discarded. Alternatively, the content features 818 can be added, along with the query data, to one or more content databases for use in future searching.

As further illustrated in FIG. 8, the storage manager 810 also includes similarity matrices 820. As discussed, the similarity matrices may be constructed to compare the content features of a query to the content features of stored content items. This results in a matrix in which each element represents a similarity of a pair of corresponding vectors from each content features series. The similarity matrices may then be used to by the ranking network to identify matching content. The storage manager 810 may also include content data 822. The content data 822 may correspond to one or more content repositories, including public content repositories, and/or private content repositories maintained by a design firm, private company, or other entity.

The storage manager 810 may further include training data 824. The training data 824 may include data used to train the embedding network 812 or the ranking network 814, as discussed above. In particular, in one or more embodiments, the training data 824 include digital content utilized by the training manager 808 to train one or more neural networks, as discussed above.

Each of the components 802-810 of the content querying system 800 and their corresponding elements (as shown in FIG. 8) may be in communication with one another using any suitable communication technologies. It will be recognized that although components 802-810 and their corresponding elements are shown to be separate in FIG. 8, any of components 802-810 and their corresponding elements may be combined into fewer components, such as into a single facility or module, divided into more components, or configured into different components as may serve a particular embodiment.

The components 802-810 and their corresponding elements can comprise software, hardware, or both. For example, the components 802-810 and their corresponding elements can comprise one or more instructions stored on a computer-readable storage medium and executable by processors of one or more computing devices. When executed by the one or more processors, the computer-executable instructions of the content querying system 800 can cause a client device and/or a server device to perform the methods described herein. Alternatively, the components 802-810 and their corresponding elements can comprise hardware, such as a special purpose processing device to perform a certain function or group of functions. Additionally, the components 802-810 and their corresponding elements can comprise a combination of computer-executable instructions and hardware.

Furthermore, the components 802-810 of the content querying system 800 may, for example, be implemented as one or more stand-alone applications, as one or more modules of an application, as one or more plug-ins, as one or more library functions or functions that may be called by other applications, and/or as a cloud-computing model. Thus, the components 802-810 of the content querying system 800 may be implemented as a stand-alone application, such as a desktop or mobile application. Furthermore, the components 802-810 of the content querying system 800 may be implemented as one or more web-based applications hosted on a remote server. Alternatively, or additionally, the components of the content querying system 800 may be implemented in a suite of mobile device applications or “apps.”

As shown, the content querying system 800 can be implemented as a single system. In other embodiments, the content querying system 800 can be implemented in whole, or in part, across multiple systems. For example, one or more functions of the content querying system 800 can be performed by one or more servers, and one or more functions of the content querying system 800 can be performed by one or more client devices. The one or more servers and/or one or more client devices may generate, store, receive, and transmit any type of data used by the content querying system 800, as described herein.

In one implementation, the one or more client devices can include or implement at least a portion of the content querying system 800. In other implementations, the one or more servers can include or implement at least a portion of the content querying system 800. For instance, the content querying system 800 can include an application running on the one or more servers or a portion of the content querying system 800 can be downloaded from the one or more servers. Additionally or alternatively, the content querying system 800 can include a web hosting application that allows the client device(s) to interact with content hosted at the one or more server(s).

For example, upon a client device accessing a webpage or other web application hosted at the one or more servers, in one or more embodiments, the one or more servers can provide a user interface through which the client device may provide a query, including a content item. Moreover, the client device can receive a request (i.e., via user input) to search for matching content to an input content item and provide the request to the one or more servers. Upon receiving the request, the one or more servers can automatically perform the methods and processes described above to identify matching content. The one or more servers can provide all or portions of the matching content, to the client device for display to the user.

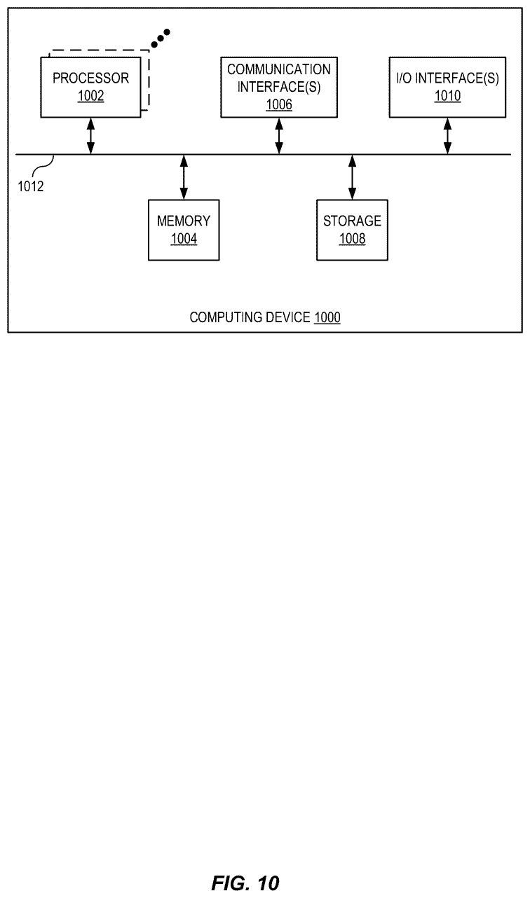

The server(s) and/or client device(s) may communicate using any communication platforms and technologies suitable for transporting data and/or communication signals, including any known communication technologies, devices, media, and protocols supportive of remote data communications, examples of which will be described in more detail below with respect to FIG. 10. In some embodiments, the server(s) and/or client device(s) communicate via one or more networks. A network may include a single network or a collection of networks (such as the Internet, a corporate intranet, a virtual private network (VPN), a local area network (LAN), a wireless local network (WLAN), a cellular network, a wide area network (WAN), a metropolitan area network (MAN), or a combination of two or more such networks. The one or more networks will be discussed in more detail below with regard to FIG. 10.

The server(s) may include one or more hardware servers (e.g., hosts), each with its own computing resources (e.g., processors, memory, disk space, networking bandwidth, etc.) which may be securely divided between multiple customers (e.g. client devices), each of which may host their own applications on the server(s). The client device(s) may include one or more personal computers, laptop computers, mobile devices, mobile phones, tablets, special purpose computers, TVs, or other computing devices, including computing devices described below with regard to FIG. 10.

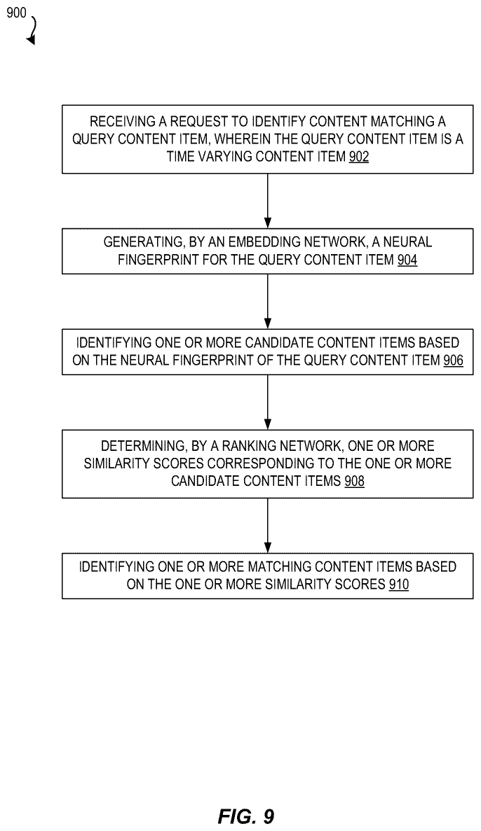

FIGS. 1-8, the corresponding text, and the examples, provide a number of different systems and devices that allows a user to fingerprint content and search for matching content using the content fingerprint. In addition to the foregoing, embodiments can also be described in terms of flowcharts comprising acts and steps in a method for accomplishing a particular result. For example, FIG. 9 illustrates a flowchart of an exemplary method in accordance with one or more embodiments. The method described in relation to FIG. 9 may be performed with fewer or more steps/acts or the steps/acts may be performed in differing orders. Additionally, the steps/acts described herein may be repeated or performed in parallel with one another or in parallel with different instances of the same or similar steps/acts.

FIG. 9 illustrates a flowchart 900 of a series of acts in a method of content querying using neural fingerprints in accordance with one or more embodiments. In one or more embodiments, the method 900 is performed in a digital medium environment that includes the content querying system 800. The method 900 is intended to be illustrative of one or more methods in accordance with the present disclosure and is not intended to limit potential embodiments. Alternative embodiments can include additional, fewer, or different steps than those articulated in FIG. 9.

As illustrated in FIG. 9, the method 900 includes an act 902 of receiving a request to identify content matching a query content item, wherein the query content item is a time varying content item. As discussed, in some embodiments, a content query system, or audio query system, receives a request from a user, system, or other entity, to determine whether an input content item (e.g., a query content item) matches any known content items in a content data store. In some embodiments, the query content item is a digital audio recording.

As illustrated in FIG. 9, the method 900 also includes an act 904 of generating, by an embedding network, a neural fingerprint for the query content item. In some embodiments, the embedding network is a neural network trained to generate neural fingerprints for digital audio recordings, wherein the digital audio recordings include one or more of music recordings, environmental recordings, or speech recordings. Initially, the query content item is fingerprinted, as discussed above. This fingerprinting process generates a neural fingerprint that represents the query content item as a series of embeddings. For example, in some embodiments, generating the neural fingerprint includes generating a series of embeddings corresponding to the query content item, wherein each embedding from the series of embeddings represents a different time interval of the query content item.

As illustrated in FIG. 9, the method 900 also includes an act 906 of identifying one or more candidate content items based on the neural fingerprint of the query content item. In some embodiments, a search index is maintained for the content data store and a nearest neighbors search algorithm may be used to identify possibly matching content. These potential search results may be sorted by the search algorithm and the most likely matches used as candidate content items.

As illustrated in FIG. 9, the method 900 also includes an act 908 of determining, by a ranking network, one or more similarity scores corresponding to the one or more candidate content items. The candidate content items are then evaluated by the ranking network to determine which candidate or candidates match the query content item. In some embodiments, similarity matrices are generated that each represent the distance between corresponding embeddings from a candidate content item and the query content item. In some embodiments, determining, by a ranking network, one or more similarity scores corresponding to the one or more candidate content items, further includes generating one or more similarity matrices based on the neural fingerprint of the query content item and the one or more candidate content items, and processing, by the ranking network, each of the one or more similarity matrices to determine the one or more similarity scores. In some embodiments, the one or more similarity scores are determined from a logit layer of the ranking network.

In some embodiments, the ranking network is a neural network trained to identify matching content from similarity matrices, wherein each element of a similarity matrix represents a distance between a query embedding and a candidate embedding. In some embodiments, the ranking network is trained by obtaining a training dataset including a plurality of training digital audio recordings, augmenting the plurality of training digital audio recordings by adding one or more of noise, pitch-shifting, or time stretching, generating a plurality of neural fingerprints corresponding to the plurality of augmented training digital audio recordings, generating a plurality of training similarity matrices based on the plurality of neural fingerprints, and training the ranking network using the plurality of training similarity matrices to identify similarity matrices that include matching content.

As illustrated in FIG. 9, the method 900 also includes an act 910 of identifying one or more matching content items based on the one or more similarity scores. For example, the content query system may return an indication of matching content (e.g., content name or other identifier) to the requestor.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 10 illustrates, in block diagram form, an exemplary computing device 1000 that may be configured to perform one or more of the processes described above. One will appreciate that one or more computing devices such as the computing device 1000 may implement the content querying system. As shown by FIG. 10, the computing device can comprise a processor 1002, memory 1004, one or more communication interfaces 1006, a storage device 1008, and one or more I/O devices/interfaces 1010. In certain embodiments, the computing device 1000 can include fewer or more components than those shown in FIG. 10. Components of computing device 1000 shown in FIG. 10 will now be described in additional detail.

In particular embodiments, processor(s) 1002 includes hardware for executing instructions, such as those making up a computer program. As an example, and not by way of limitation, to execute instructions, processor(s) 1002 may retrieve (or fetch) the instructions from an internal register, an internal cache, memory 1004, or a storage device 1008 and decode and execute them. In various embodiments, the processor(s) 1002 may include one or more central processing units (CPUs), graphics processing units (GPUs), field programmable gate arrays (FPGAs), systems on chip (SoC), or other processor(s) or combinations of processors.

The computing device 1000 includes memory 1004, which is coupled to the processor(s) 1002. The memory 1004 may be used for storing data, metadata, and programs for execution by the processor(s). The memory 1004 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 1004 may be internal or distributed memory.

The computing device 1000 can further include one or more communication interfaces 1006. A communication interface 1006 can include hardware, software, or both. The communication interface 1006 can provide one or more interfaces for communication (such as, for example, packet-based communication) between the computing device and one or more other computing devices 1000 or one or more networks. As an example and not by way of limitation, communication interface 1006 may include a network interface controller (NIC) or network adapter for communicating with an Ethernet or other wire-based network or a wireless NIC (WNIC) or wireless adapter for communicating with a wireless network, such as a WI-FI. The computing device 1000 can further include a bus 1012. The bus 1012 can comprise hardware, software, or both that couples components of computing device 1000 to each other.

The computing device 1000 includes a storage device 1008 includes storage for storing data or instructions. As an example, and not by way of limitation, storage device 1008 can comprise a non-transitory storage medium described above. The storage device 1008 may include a hard disk drive (HDD), flash memory, a Universal Serial Bus (USB) drive or a combination these or other storage devices. The computing device 1000 also includes one or more input or output (“I/O”) devices/interfaces 1010, which are provided to allow a user to provide input to (such as user strokes), receive output from, and otherwise transfer data to and from the computing device 1000. These I/O devices/interfaces 1010 may include a mouse, keypad or a keyboard, a touch screen, camera, optical scanner, network interface, modem, other known I/O devices or a combination of such I/O devices/interfaces 1010. The touch screen may be activated with a stylus or a finger.

The I/O devices/interfaces 1010 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O devices/interfaces 1010 is configured to provide graphical data to a display for presentation to a user. The graphical data may be representative of one or more graphical user interfaces and/or any other graphical content as may serve a particular implementation.

In the foregoing specification, embodiments have been described with reference to specific exemplary embodiments thereof. Various embodiments are described with reference to details discussed herein, and the accompanying drawings illustrate the various embodiments. The description above and drawings are illustrative of one or more embodiments and are not to be construed as limiting. Numerous specific details are described to provide a thorough understanding of various embodiments.

Embodiments may include other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the various embodiments described above, unless specifically noted otherwise, disjunctive language such as the phrase “at least one of A, B, or C,” is intended to be understood to mean either A, B, or C, or any combination thereof (e.g., A, B, and/or C). As such, disjunctive language is not intended to, nor should it be understood to, imply that a given embodiment requires at least one of A, at least one of B, or at least one of C to each be present.

We claim:

1. A method comprising:
receiving a request to identify content matching a query content item, wherein the query content item is a time varying content item;
generating, by an embedding network, a neural fingerprint for the query content item;
identifying one or more candidate content items based on the neural fingerprint of the query content item;
determining, by a ranking network, one or more similarity scores corresponding to the one or more candidate content items; and
identifying one or more matching content items based on the one or more similarity scores.

2. The method of claim 1, wherein the embedding network is a neural network trained to generate neural fingerprints for digital audio recordings, wherein the digital audio recordings include one or more of music recordings, environmental recordings, or speech recordings.

3. The method of claim 1, wherein generating, by an embedding network, a neural fingerprint for the query content item, further comprises:
generating a series of embeddings corresponding to the query content item, wherein each embedding from the series of embeddings represents a different time interval of the query content item.

4. The method of claim 1, wherein determining, by a ranking network, one or more similarity scores corresponding to the one or more candidate content items, further comprises:
generating one or more similarity matrices based on the neural fingerprint of the query content item and the one or more candidate content items; and
processing, by the ranking network, each of the one or more similarity matrices to determine the one or more similarity scores.

5. The method of claim 4, wherein the ranking network is a neural network trained to identify matching content from similarity matrices, wherein each element of a similarity matrix represents a distance between a query embedding and a candidate embedding.

6. The method of claim 5, wherein the ranking network is trained by:
obtaining a training dataset including a plurality of training digital audio recordings;
augmenting the plurality of training digital audio recordings by adding one or more of noise, pitch-shifting, or time stretching;
generating a plurality of neural fingerprints corresponding to the plurality of augmented training digital audio recordings;
generating a plurality of training similarity matrices based on the plurality of neural fingerprints; and
training the ranking network using the plurality of training similarity matrices to identify similarity matrices that include matching content.

7. The method of claim 5, wherein the one or more similarity scores are determined from a logit layer of the ranking network.

8. The method of claim 1, wherein the query content item is a digital audio recording.

9. A non-transitory computer-readable medium storing executable instructions, which when executed by a processing device, cause the processing device to perform operations comprising:
receiving a request to identify content matching a query content item, wherein the query content item is a time varying content item;
generating, by an embedding network, a neural fingerprint for the query content item;
identifying one or more candidate content items based on the neural fingerprint of the query content item;
determining, by a ranking network, one or more similarity scores corresponding to the one or more candidate content items; and
identifying one or more matching content items based on the one or more similarity scores.

10. The non-transitory computer-readable medium of claim 9, wherein the embedding network is a neural network trained to generate neural fingerprints for digital audio recordings, wherein the digital audio recordings include one or more of music recordings, environmental recordings, or speech recordings.

11. The non-transitory computer-readable medium of claim 9, wherein the operation of generating, by an embedding network, a neural fingerprint for the query content item, further comprises:
generating a series of embeddings corresponding to the query content item, wherein each embedding from the series of embeddings represents a different time interval of the query content item.

12. The non-transitory computer-readable medium of claim 9, wherein the operation of determining, by a ranking network, one or more similarity scores corresponding to the one or more candidate content items, further comprises:
generating one or more similarity matrices based on the neural fingerprint of the query content item and the one or more candidate content items; and
processing, by the ranking network, each of the one or more similarity matrices to determine the one or more similarity scores.

13. The non-transitory computer-readable medium of claim 12, wherein the ranking network is a neural network trained to identify matching content from similarity matrices, wherein each element of a similarity matrix represents a distance between a query embedding and a candidate embedding.

14. The non-transitory computer-readable medium of claim 13, wherein the ranking network is trained by:
obtaining a training dataset including a plurality of training digital audio recordings;
augmenting the plurality of training digital audio recordings by adding one or more of noise, pitch-shifting, or time stretching;
generating a plurality of neural fingerprints corresponding to the plurality of augmented training digital audio recordings;
generating a plurality of training similarity matrices based on the plurality of neural fingerprints; and
training the ranking network using the plurality of training similarity matrices to identify similarity matrices that include matching content.

15. The non-transitory computer-readable medium of claim 14, wherein the one or more similarity scores are determined from a logit layer of the ranking network.

16. The non-transitory computer-readable medium of claim 9, wherein the query content item is a digital audio recording.

17. A system comprising:
a memory component; and
a processing device coupled to the memory component, the processing device to perform operations comprising:
receiving a request to identify audio content matching a query audio recording;
generating, by an embedding network, a neural fingerprint for the query audio recording;
identifying one or more candidate audio recordings based on the neural fingerprint of the query audio recording;
determining, by a ranking network, one or more similarity scores corresponding to the one or more candidate audio recordings; and
identifying one or more matching audio recordings based on the one or more similarity scores.

18. The system of claim 17, wherein the operation of determining, by a ranking network, one or more similarity scores corresponding to the one or more candidate audio recordings, further comprises:
generating one or more similarity matrices based on the neural fingerprint of the query audio recording and the one or more candidate audio recordings; and
processing, by the ranking network, each of the one or more similarity matrices to determine the one or more similarity scores.

19. The system of claim 18, wherein the ranking network is a neural network trained to identify matching content from similarity matrices, wherein each element of a similarity matrix represents a distance between a query embedding and a candidate embedding.

20. The system of claim 19, wherein the ranking network is trained by:
obtaining a training dataset including a plurality of training digital audio recordings;
augmenting the plurality of training digital audio recordings by adding one or more of noise, pitch-shifting, or time stretching;
generating a plurality of neural fingerprints corresponding to the plurality of augmented training digital audio recordings;
generating a plurality of training similarity matrices based on the plurality of neural fingerprints; and
training the ranking network using the plurality of training similarity matrices to identify similarity matrices that include matching content.
